(19) United States
(12) Patent Application Publication
(10) Pub. No.: US 2025/0007302 A1
(43) Pub. Date: Jan. 2, 2025

(54) REVERSE POLARITY TURN-ON CIRCUIT FOR FLOATING FET DRIVER

(71) Applicant: TEXAS INSTRUMENTS INCORPORATED, Dallas, TX (US)

(72) Inventor: Ashish OJHA, Bangalore (IN)

(21) Appl. No.: 18/344,412

(22) Filed: Jun. 29, 2023

(51) Int. Cl. H02J 7/00; H02H 11/00

(52) U.S. Cl. CPC H02J 7/0034; H02H 11/003

(57) ABSTRACT

In an example, a circuit includes a first transistor having a control terminal coupled to a voltage terminal, having a first terminal coupled to a ground terminal, and having a second terminal. The circuit also includes a second transistor having a control terminal coupled to the second terminal of the first transistor, having a first terminal coupled to the ground terminal, and having a second terminal. The circuit includes a diode having a first terminal coupled to the control terminal of the second transistor and having a second terminal coupled to a load terminal. The circuit also includes a third transistor having a control terminal coupled to the second terminal of the second transistor, a first terminal coupled to the voltage terminal, and a second terminal coupled to the load terminal.

### BACKGROUND

Many electronic systems include one or more batteries to provide power. If a battery is connected in reverse polarity (e.g., the positive and negative terminals are switched), the electronic system may be damaged. A reverse polarity situation may occur during assembly or repair of the electronic system. Automotive systems and other systems may have requirements to support a reverse polarity battery connection to protect the electronic system.

### SUMMARY

In accordance with at least one example of the description, a circuit includes a first transistor having a control terminal coupled to a voltage terminal, having a first terminal coupled to a ground terminal, and having a second terminal. The circuit also includes a second transistor having a control terminal coupled to the second terminal of the first transistor, having a first terminal coupled to the ground terminal, and having a second terminal. The circuit includes a diode having a first terminal coupled to the control terminal of the second transistor and having a second terminal coupled to a load terminal. The circuit also includes a third transistor having a control terminal coupled to the second terminal of the second transistor, a first terminal coupled to the voltage terminal, and a second terminal coupled to the load terminal.

In accordance with at least one example of the description, a circuit includes a first transistor having a control terminal coupled to a voltage terminal, having a first terminal coupled to a ground terminal, and having a second terminal, the first transistor configured to turn on responsive to a voltage source being in a reverse polarity. The circuit includes a second transistor having a control terminal coupled to the second terminal of the first transistor, having a first terminal coupled to the ground terminal, and having a second terminal, the second transistor configured to turn on responsive to the first transistor turning on. The circuit also includes a diode having a first terminal coupled to the control terminal of the second transistor and having a second terminal coupled to a load terminal. The circuit includes a third transistor having a control terminal coupled to the second terminal of the second transistor, a first terminal coupled to the voltage terminal, and a second terminal coupled to the load terminal, the third transistor configured to turn on responsive to the second transistor turning on.

In accordance with at least one example of the description, a method includes detecting a reverse polarity of a voltage source, where the voltage source is configured to provide a voltage to a driver circuit. The method also includes, responsive to detecting the reverse polarity of the voltage source, turning on a first transistor. The method includes, responsive to turning on the first transistor, turning on a second transistor. The method also includes, responsive to turning on the second transistor, turning on a third transistor, where the third transistor provides a path for a reverse polarity parasitic current in the third transistor.

### BRIEF DESCRIPTION OF THE DRAWINGS

FIG. 1 is a circuit for reverse polarity turn-on in accordance with various examples.

FIG. 2 is a circuit of a driver with reverse polarity in accordance with various examples.

FIG. 3A is a circuit of a high-side field effect transistor (FET) in reverse polarity in accordance with various examples.

FIG. 3B is a circuit of a high-side FET in reverse polarity in accordance with various examples.

FIG. 3C is a cross-section of a high-side FET in accordance with various examples.

FIG. 4 is a circuit of a high-side FET during reverse polarity turn-on in accordance with various examples.

FIG. 5 is a circuit for reverse polarity turn-on of a high-side FET in accordance with various examples.

FIG. 6 is a flow diagram of a method for reverse polarity turn-on in accordance with various examples.

The same reference numbers or other reference designators are used in the drawings to designate the same or similar (functionally and/or structurally) features.

### DETAILED DESCRIPTION

If a battery is connected in reverse polarity, electronic systems may be damaged. In automotive systems, electronic systems should be able to survive a reverse polarity connection. A blocking transistor, such as a FET, is included in some circuits to survive the reverse polarity condition. During reverse polarity, the load current flows through the body diode of the FET. However, if the FET is used as a high-side FET, this creates the possibility of a parasitic turn-on of a PNPN junction within the FET, which forms a silicon controlled rectifier (SCR)-type structure. An SCR is a current controlling device that has four layers (a first P-type layer, a first N-type layer, a second P-type layer, and a second N-type layer (PNPN)). If the SCR-type structure turns on, positive feedback creates a very high current within the FET that can damage the circuit. For the electronic system to survive the reverse polarity condition, the SCR action should be suppressed. Some existing systems for suppressing the SCR action affect the switching slew rate of the driver circuit or have slow response times due to capacitor sizes. Some existing systems for suppressing the SCR action affect the clamping protection in the driver circuit. Some existing systems for suppressing the SCR action do not work with higher voltage circuits.

In examples herein, a reverse polarity turn-on circuit is coupled to a control terminal of a high-side FET in a driver circuit. During a reverse polarity condition, the reverse polarity turn-on circuit detects the reverse polarity and turns on the high-side FET to provide a channel for current to flow through the high-side FET, rather than flowing through the body diode of the high-side FET. If the current flows only through the channel of the high-side FET, the parasitic SCR within the high-side FET is not triggered. The circuit is therefore protected from the high current caused by the SCR action. In examples herein, the turn-on circuit acts rapidly to prevent the SCR action. The turn-on circuit does not interfere with the operation of the high-side FET during normal operating conditions. Clamping circuitry in the driver circuit and the switching slew rate of the driver circuit are not affected by the reverse polarity turn-on circuit. In some examples, additional blocking diodes or isolation circuitry is not needed for the reverse polarity turn-on circuit.

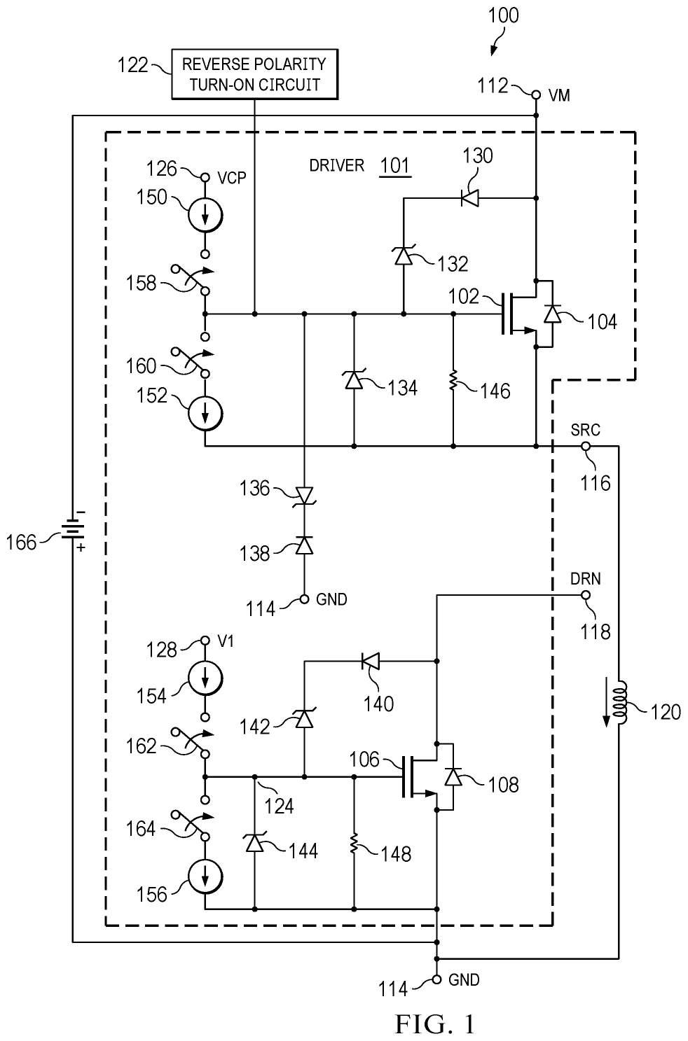

FIG. 1 is a circuit 100 for reverse polarity turn-on in accordance with various examples herein. Circuit 100 includes an example floating FET driver 101 that may be useful for driving a variety of loads, such as a small relay, a solenoid, or a light emitting diode (LED). Circuit 100 may be present in automotive systems. Circuit 100 includes a high-side FET 102 with a body diode 104, and a low-side FET 106 with a body diode 108. High-side FET 102 and low-side FET 106 may be N-type FETs in one example. Circuit 100 includes a battery 110 coupled to a voltage terminal 112 (that provides a voltage VM) and a ground terminal (GND) 114. Circuit 100 includes a source (SRC) terminal 116 and a drain (DRN) terminal 118. A load 120 may be coupled between the SRC terminal 116 and ground terminal 114.

Circuit 100 includes a reverse polarity turn-on circuit 122. High-side FET 102 includes a control terminal (e.g., a gate), a first terminal (e.g., a drain), and a second terminal (e.g., a source). The control terminal of high-side FET 102 is coupled to reverse polarity turn-on circuit 122. The first terminal of high-side FET 102 is coupled to voltage terminal 112. The second terminal of high-side FET 102 is coupled to SRC terminal 116 (e.g., a load terminal). Low-side FET 106 includes a control terminal (e.g., a gate), a first terminal (e.g., a drain), and a second terminal (e.g., a source). The control terminal of low-side FET 106 is coupled to node 124. The first terminal of low-side FET 106 is coupled to DRN terminal 118. The second terminal of low-side FET 106 is coupled to ground terminal 114.

Circuit 100 includes voltage terminal 126 (which produces a voltage VCP) and voltage terminal 128 (which produces a voltage V1). Circuit 100 also includes diodes 130, 132, 134, 136, and 138 on the high side of driver 101. Circuit 100 includes diodes 140, 142, and 144 on the low side of driver 101. Circuit 100 includes resistors 146 and 148. Circuit 100 also includes current sources 150, 152, 154, and 156. Circuit 100 includes switches 158, 160, 162, and 164. Circuit 100 also includes a battery 166, which is a voltage source for circuit 100.

In operation, driver 101 switches high-side FET 102 and low-side FET 106 on and off to provide a current path to a load 120. Diodes 130, 132, 134, 136, 138, and provide protection to high-side FET 102 under operating modes described herein. Diodes 130 and 132 provide a clamp between the gate (e.g., control terminal) and drain of high-side FET 102. This clamp turns on high-side FET 102 if the drain to source voltage V_{DS} goes up, which limits the V_{DS}. Diode 134 protects the gate to source voltage V_{GS} of high-side FET 102. Diodes 136 and 138 provide a ground to gate clamp for high-side FET 102. If high-side FET 102 is turned off, the voltage at SRC terminal 116 may go negative (such as −20 to −30 V) due to an load 120 being an inductive lode. The ground to gate clamp of diodes 136 and 138 limits the negative voltage within driver 101 by turning on high-side FET 102 if the voltage at SRC terminal 116 goes above a predetermined clamping voltage.

In operation, if low-side FET 106 is turned on, the voltage at DRN terminal 118 goes higher than the supply voltage due to load 120 being an inductive load. Diodes 140 and 142 provide a drain to gate clamp for low-side FET 106 to turn on low-side FET 106 if the drain to source voltage V_{DS} goes up, which limits the V_{DS}. Diode 144 protects the gate to source voltage V_{GS} of low-side FET 106.

Current sources 150, 152, and switches 158, 160 provide a voltage or signal at the control terminal (e.g., the gate) of high-side FET 102 to turn on and off the high-side FET 102 during operation. A controller or other circuitry (not shown in FIG. 1) may operate switches 158 and 160. Current sources 154, 156, and switches 162, 164 provide a voltage or signal at the control terminal (e.g., the gate) of low-side FET 106 to turn on and off the low-side FET 106 during operation. A controller or other circuitry (not shown in FIG. 1) may operate switches 162 and 164.

In examples herein, reverse polarity turn-on circuit 122 provides reverse polarity protection for driver 101 without interfering with the operation of the other components of driver 101, such as the protection diodes and switches described above. The switching slew rate of driver 101 is also not affected. The reverse polarity turn-on circuit 122 turns on high-side FET 102 quickly to prevent the start of SCR action.

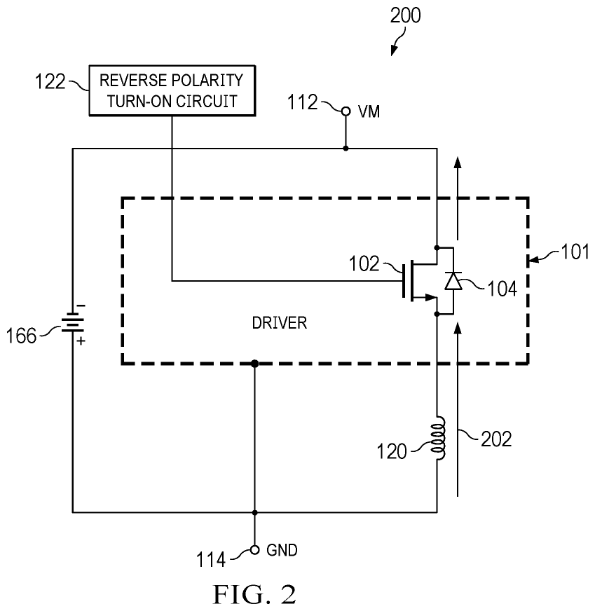

FIG. 2 is a circuit 200 of a driver with reverse polarity in accordance with various examples herein. In FIG. 2, some of the circuit elements are described above with respect to FIG. 1, and like numeral denote like components.

Circuit 200 includes a driver 101, high-side FET 102, body diode 104, voltage terminal 112, and ground terminal 114. The other components of driver 101 are not shown in FIG. 2 for simplicity. Circuit 200 also includes load 120, reverse polarity turn-on circuit 122, battery 166, and current 202. In this example, the battery terminals of battery 166 are reversed, which is shown by the negative terminal (indicated with a minus sign above battery 166) coupled to voltage terminal 112, and the positive terminal (indicated with a plus sign below battery 166) coupled to ground terminal 114. The current 202 represents a steady state load current, that may be limited by the inductance or resistance of load 120. In this situation, the high-side FET 102 should not break down or be damaged during reverse polarity of battery 166. In examples herein, reverse polarity turn-on circuit 122 detects that the battery 166 is in reverse polarity and turn on high-side FET 102 responsive to the detection. Turning on high-side FET 102 allows the current 202 to flow through the channel in high-side FET 102 rather than through body diode 104. This prevents damage to high-side FET 102 during the reverse polarity situation.

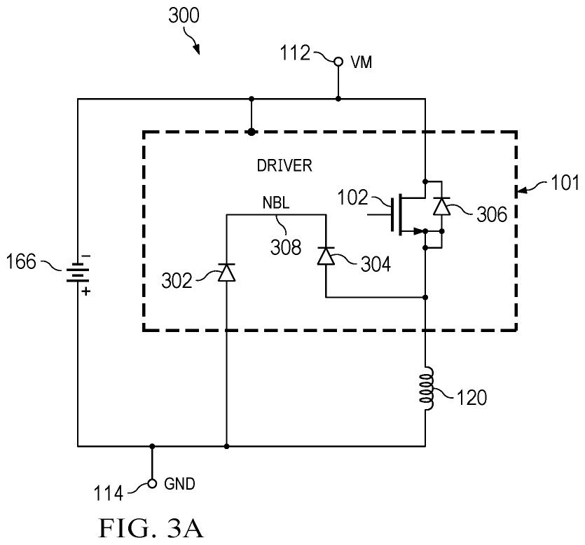

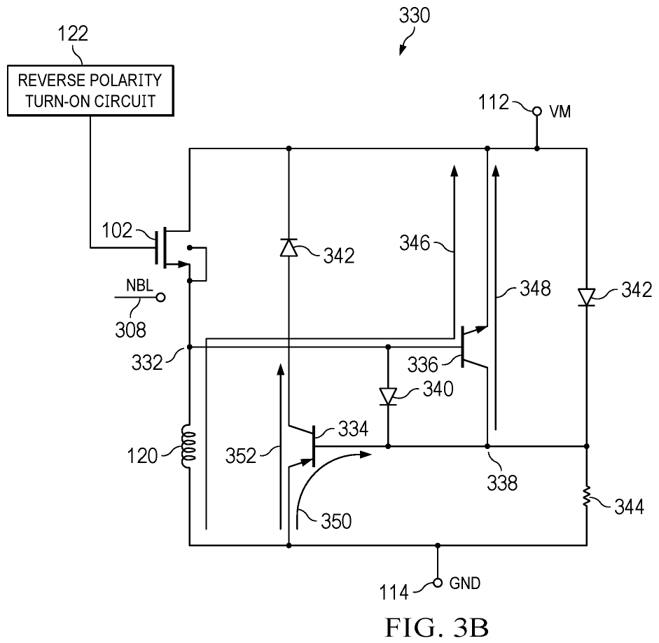

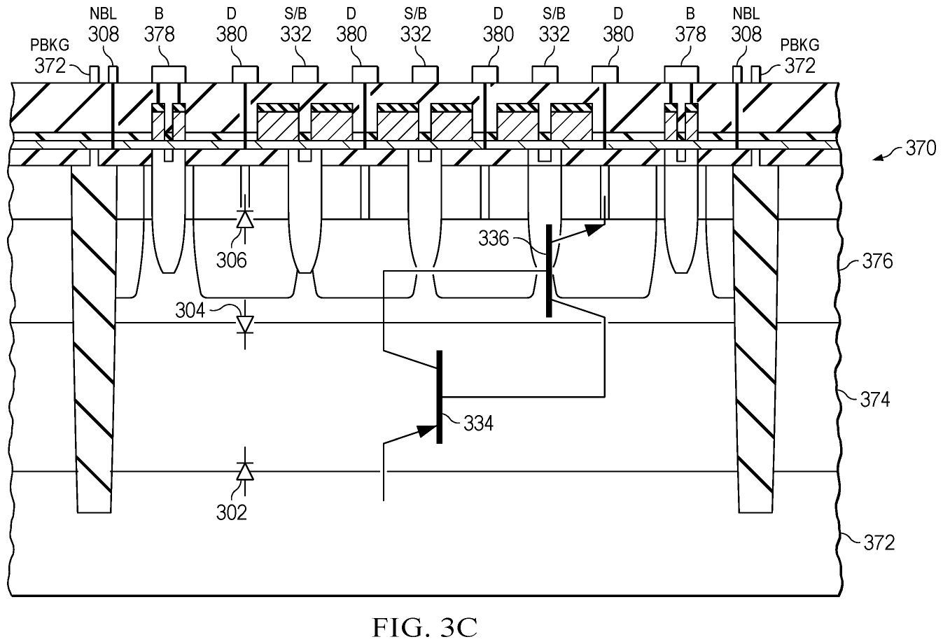

FIGS. 3A, 3B, and 3C are diagrams that show the SCR action in high-side FET 102 during reverse polarity in accordance with various examples herein. Various parasitic diodes and currents are shown in FIGS. 3A, 3B, and 3C. In FIGS. 3A, 3B, and 3C, some of the circuit elements are described above with respect to FIGS. 1 and 2, and like numeral denote like components.

FIG. 3A is a circuit 300 of a high-side FET 102 in reverse polarity in accordance with various examples herein. Circuit 300 includes high-side FET 102, voltage terminal 112, ground terminal 114, and load 120. Battery 166 is connected in reverse polarity, with the negative battery terminal coupled to voltage terminal 112 and the positive battery terminal coupled to ground terminal 114. In reverse polarity, battery 166 may provide a voltage of −30 V at voltage terminal 112 and a voltage of 0 V at ground terminal 114 in one example. Circuit 300 also includes diodes 302, 304, and 306. These diodes represent parasitic diodes that form an SCR type structure in high-side FET 102 during reverse polarity. Parasitic diode 302 is formed between a P-type substrate (which may be referred to as a protected back gate (PBKG)) that is at ground (e.g., ground terminal 114) and an N-type buried layer (NBL) 308. Parasitic diode 304 is formed between NBL 308 and a body portion of high-side FET 102 that is P-type doped. Parasitic diode 306 is formed between the P-type doped body portion and the drain terminal of high-side FET 102, which is coupled to voltage terminal 112 in this example. The drain is N-type doped in this example. The substrate is P-type doped, the NBL 308 is N-type doped, the body portion is P-type doped, and the drain is N-type doped. Therefore, these parasitics form a PNPN structure, which is an SCR. FIGS. 3B and 3C provide additional description of the structure and operation of the SCR in high-side FET 102.

FIG. 3B is a circuit 330 of a high-side FET 102 in reverse polarity in accordance with various examples herein. Circuit 330 shows various currents that may flow through high-side FET 102 during reverse polarity. Circuit 330 includes high-side FET 102, voltage terminal 112, ground terminal 114, load 120, reverse polarity turn-on circuit 122, and NBL 308. NBL 308 is shown as a floating terminal next to high-side FET 102. In high-side FET 102, the body terminal is shorted to the source as shown, and this S/B node is labeled as node 332. Circuit 330 also includes parasitic transistors 334 and 336, which represent the parasitics that create the SCR action during reverse polarity. Transistor 334 is a PNP device, which is P-type at its emitter (e.g., ground terminal 114), N-type at its base (node 338, which is also NBL 308), and P-type at its collector (node 332, the S/B node). Transistor 336 is an NPN device, which is N-type at its collector (node 338), P-type at its base (node 332), and N-type at its emitter (voltage terminal 112). Circuit 330 includes diodes 340 and 342, which represent PN junctions. Diode 340 represents the PN junction of the collector-base of transistor 334. Diode 342 represents the PN junction of the base-emitter of transistor 336. Circuit 330 includes diode 342 and resistor 344. Diode 342 is a blocking diode for biasing NBL 308 (e.g., node 338) and for blocking a PBKG to NBL diode from becoming forward biased during reverse polarity. Resistor 334 provides a path to ground. Circuit 330 also includes four currents: 346, 348, 350, and 352. These four currents represent the currents through high-side FET 102 during reverse polarity. In reverse polarity, the voltage terminal 112 may be at −30 V and the ground terminal 114 may be at 0 V.

During reverse polarity, first current 346 begins flowing through load 120 and the body diode of high-side FET 102. The source and body of high-side FET 102 are shorted together at node 332 (S/B node) as described above. The body diode of high-side FET 102 is not shown in FIG. 3B, but is represented by the base-emitter junction of transistor 336. Responsive to first current 346 flowing, transistor 336 is turned on and second current 348 begins flowing from the collector to the emitter of transistor 336. Second current 348 flows from a P-type PBKG substrate to an N-type layer, represented by node 338 (NBL 308). Responsive to second current 348 flowing, third current 350 begins flowing through transistor 334. The flow of third current 350 increases the flow of fourth current 352 from ground terminal 114 to node 332, at the collector of transistor 334. Therefore, these four currents 346, 348, 350, and 352 form a positive feedback system that produces a very high current flowing from ground terminal 114 at 0 V to voltage terminal 112 at −30 V. These currents represent the parasitic SCR action in high-side FET 102. If the parasitic SCR action is not suppressed, high-side FET 102 and other circuit components may be damaged.

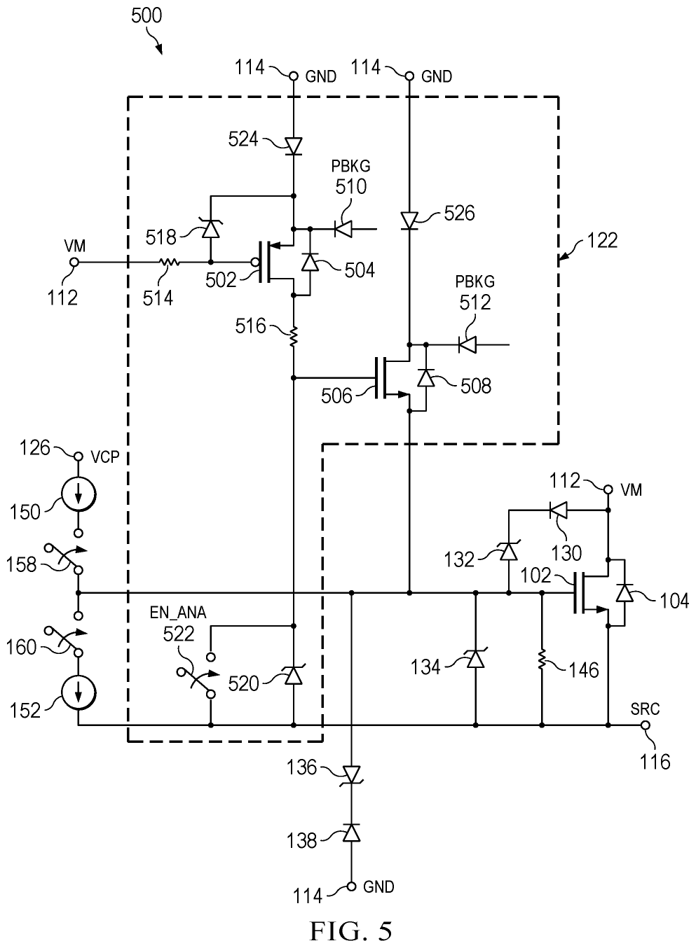

In examples herein, reverse polarity turn-on circuit 122 detects the reverse polarity condition and turns on high-side FET 102. The first step in the SCR action is the first current 346 flowing through body diode 104 (not shown in FIG. 3B). If that current can be avoided, the SCR action is not triggered. If high-side FET 102 is turned on during reverse polarity, first current 346 will flow through the channel of high-side FET 102 rather than body diode 104. The operation of an example reverse polarity turn-on circuit 122 is described with respect to FIG. 5 below.

FIG. 3C is a cross-section 370 of a high-side FET 102 in accordance with various examples herein. In FIG. 3C, some of the elements are described above with respect to FIGS. 3A and 3B, and like numeral denote like components. Cross-section 370 shows the parasitic diodes 302, 304, 306, and transistors 334 and 336. These parasitic components are formed in the various PN junctions within high-side FET 102. High-side FET 102 includes a P-type layer 372 (e.g., PBKG 372), an N-type layer 374 (which is NBL 308 in an example), and another P-type layer 376. The PN junctions of parasitic diodes 302, 304, 306, and transistors 334 and 336 are formed at the junctions of these layers, and with the doped regions shown above P-type layer 376 in FIG. 3C.

Cross-section 370 also shows various terminals of high-side FET 102 at the top of the figure, including connections for NBL 308 and node 332 (S/B node). Terminals are also shown for PBKG 372, body (B) terminal 378, and drain (D) 380.

As described above, the parasitic diodes 302, 304, 306, and transistors 334 and 336 form an SCR type structure in high-side FET 102 that is turned on during reverse polarity. In examples herein, reverse polarity turn-on circuit 122 prevents the SCR from turning on during reverse polarity and therefore protects high-side FET 102.

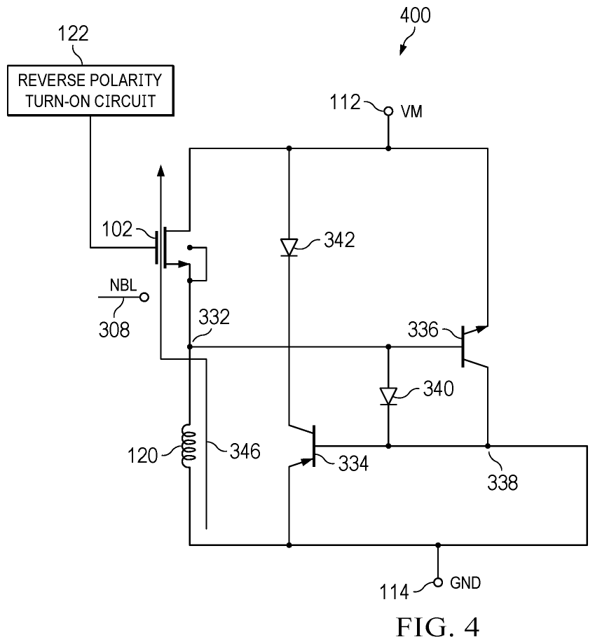

FIG. 4 is a circuit 400 of high-side FET 102 during reverse polarity turn-on in accordance with various examples herein. In FIG. 4, some of the elements are described above with respect to FIGS. 3A and 3B, and like numeral denote like components. In circuit 400, reverse polarity turn-on circuit 122 has detected the reverse polarity condition and turned on high-side FET 102 to provide a path for current to flow through high-side FET 102. Circuit 400 includes high-side FET 102, voltage terminal 112, ground terminal 114, load 120, and reverse polarity turn-on circuit 122. Circuit 400 also includes NBL 308, node 332, parasitic transistors 334 and 336, node 338, and diodes 340 and 342. Circuit 400 also show first current 346 flowing through load 120 during reverse polarity.

In this example, high-side FET 102 is turned on during reverse polarity by reverse polarity turn-on circuit 122. Therefore, first current 346 flows through the channel of high-side FET 102, rather than through the body diode of high-side FET 102. High-side FET 102 is turned on by increasing the gate to drain voltage of high-side FET 102 until it is higher than the threshold voltage. In some examples, circuit 400 operates as described if the voltage drop across high-side FET 102 is lesser than the diode voltage (V_{DIODE}) of the body diode 104. The voltage drop across the high-side FET 102 is the load current I_{LOAD} multiplied by the on resistance (from drain to source) R_{DSON} of high-side FET 102. If this voltage drop becomes larger than the diode voltage of the body diode 104, body diode 104 begins conduction and the SCR action will trigger. Therefore, the load current that the device can survive without the SCR triggering may be derived by the relationship I_{LOAD}*R_{DSON}<V_{DIODE}.

FIG. 5 is a circuit 500 for reverse polarity turn-on of the high-side FET 102 in accordance with various examples herein. In FIG. 5, some of the elements are described above with respect to FIG. 1, and like numeral denote like components. Circuit 500 shows the circuit elements coupled to high-side FET 102 as shown in FIG. 1. Circuit 500 also provides one example of the circuitry inside reverse polarity turn-on circuit 122. In examples herein, reverse polarity turn-on circuit 122 quickly detects if battery 166 (not shown in FIG. 5) is in reverse polarity, and responsive to the detection, turns on high-side FET 102. Reverse polarity turn-on circuit 122 does not affect the clamping operations for high-side FET 102, and the switching slew rate of the driver 101 is not significantly affected, if at all. Reverse polarity turn-on circuit 122 operates quickly enough to prevent the start of SCR action in high-side FET 102 as described above.

Circuit 500 includes high-side FET 102, body diode 104, and the various circuit components coupled to high-side FET 102, such as diodes 130, 132, and 134, resistor 146, etc. A detailed description of those components is provided above with respect to FIG. 1. Circuit 500 provides one example of the circuitry inside reverse polarity turn-on circuit 122. In this example, reverse polarity turn-on circuit 122 includes transistor 502, which has a body diode 504. Reverse polarity turn-on circuit 122 also includes transistor 506 that has a body diode 508. Transistor 502 includes a PBKG diode 510, and transistor 506 includes a PBKG diode 512. Reverse polarity turn-on circuit 122 includes resistors 514 and 516, and includes diodes 518 and 520. Reverse polarity turn-on circuit 122 also includes switch 522 and diodes 524 and 526. Diodes 524 and 526 are optional and may not be included in all examples.

Transistor 502 is a P-type FET in this example, although another type of transistor may be useful in other examples. Transistor 502 includes a gate (e.g., a control terminal) coupled to a first terminal of resistor 514. Resistor 514 has a second terminal coupled to voltage terminal 112, which is one terminal of battery 166. Transistor 502 includes a source (e.g., a first terminal) coupled to ground terminal 114. Blocking diode 524 may be present between the source of transistor 502 and ground terminal 114. Blocking diode 524 blocks current from flowing to ground terminal 114. However, PBKG diode 510 may provide the same function in the absence of blocking diode 524.

Transistor 502 includes a drain terminal (e.g., a second terminal) coupled to resistor 516. A diode 518 is coupled between the gate and source of transistor 502. Diode 518 may be a Zener diode that protects the gate to source voltage of transistor 502 in one example.

Transistor 506 is an N-type FET in this example, although another type of transistor may be useful in other examples. Transistor 506 includes a gate (e.g., a control terminal) coupled to resistor 516 and to diode 520. Transistor 506 also includes a drain (e.g., a first terminal) coupled to ground terminal 114. Blocking diode 526 may be present between the drain of transistor 506 and ground terminal 114. Blocking diode 526 blocks current from flowing to ground terminal 114. However, PBKG diode 512 may provide the same function in the absence of blocking diode 526. Transistor 502 includes a source (e.g., a second terminal) coupled to the gate of high-side FET 102.

Diode 520 may be a Zener diode in one example. Switch 522 may have a first terminal coupled to the anode of diode 520, and a second terminal coupled to the cathode of diode 520. Switch 522 may be operated with an enable signal (EN_ANA) from a controller, processor, or other circuitry (not shown in FIG. 5).

Reverse polarity turn-on circuit 122 provides a pathway for turning on high-side FET 102 in reverse polarity. If the battery 166 is connected in reverse polarity, the voltage at ground terminal 114 is higher than the voltage at voltage terminal 112. This condition creates a source-to-gate voltage across transistor 502 that turns on transistor 502. Transistor 502 turn on quickly responsive to the battery being in reverse polarity.

Transistor 506 is coupled to transistor 502 in a source follower configuration. Responsive to transistor 502 turning on, transistor 502 provides current to resistor 516. This current turns on transistor 506 because the voltage at the gate of transistor 506 is raised higher than the voltage at the source of transistor 506. Diode 520 is a Zener diode that provides protection by preventing the voltage at the source of transistor 506 from rising above 5 V in one example. If transistor 506 is on, current flows through transistor 506 to the gate of high-side FET 102, which is coupled to the source of transistor 506. The current provided to the gate of high-side FET 102 turns on high-side FET 102, because the voltage at the gate of high-side FET 102 is raised higher than the voltage at the source of high-side FET 102.

In sum, reverse polarity turn-on circuit 122 detects the reverse polarity with transistor 502. Transistor 502 turns on quickly responsive to the battery being in reverse polarity, which turns on transistor 506, which then turns on high-side FET 102. Transistor 506 is a source follower that quickly charges the gate of high-side FET 102 to turn on high-side FET 102. With high-side FET 102 turned on, the current that flows during reverse polarity may flow through the channel of high-side FET 102, and prevent damage to high-side FET 102.

During active operation of driver 101, the voltage at the gate of transistor 506 may be pulled down to the voltage at SRC terminal 116 by closing switch 522. Therefore, during normal operation (e.g., normal polarity of battery 166) of driver 101, the gate to source voltage of transistor 506 does not change, and transistor 506 will not turn on. Switch 522 may be implemented with any suitable circuitry, such as an N-type FET in one example. During reverse polarity of battery 166, the circuit that closes switch 522 would be inactive, and therefore switch 522 would open so transistor 506 could turn on as described above.

Reverse polarity turn-on circuit 122 turns on transistor 502 only in the presence of a reverse polarity of battery 166. Transistor 502 provides detection of reverse polarity, and transistor 506 provides a fast turn-on path for high-side FET 102. Having separate detection circuitry and turn-on circuitry in reverse polarity turn-on circuit 122 provides a faster process for turning on high-side FET 102. Also, no high current paths are created during reverse polarity inside reverse polarity turn-on circuit 122. In the active mode of driver 101, reverse polarity turn-on circuit 122 is safely disable because the voltage at ground terminal 114 is below the voltage at voltage terminal 112, which keeps transistor 502 off. Therefore, transistor 502 does not interfere with the active operation of driver 101.

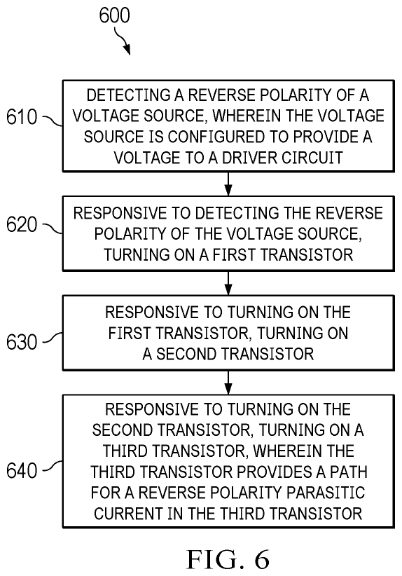

FIG. 6 is a flow diagram of a method 600 for reverse polarity turn-on in accordance with various examples herein. The steps of method 600 may be performed in any suitable order. The hardware components described above with respect to FIGS. 1 and 5 may perform method 600 in some examples. Any suitable hardware, software, or digital logic may perform method 600 in some examples.

Method 600 begins at 610, where circuitry detects a reverse polarity of a voltage source, where the voltage source is configured to provide a voltage to a driver circuit. In one example, the voltage source is battery 166, and the battery 166 provides a voltage to driver 101. The circuitry that detects the reverse polarity is reverse polarity turn-on circuit 122.

Method 600 continues at 620, where responsive to detecting the reverse polarity of the voltage source, the reverse polarity turn-on circuit 122 turns on a first transistor. In this example, transistor 502 is the first transistor. Transistor 502 turns on if the voltage at ground terminal 114 is higher than the voltage at voltage terminal 112, which occurs if battery 166 is connected in reverse polarity.

Method 600 continues at 630, where responsive to turning on the first transistor (transistor 502), the reverse polarity turn-on circuit 122 turns on a second transistor. In this example, transistor 506 is the second transistor. Transistor 506 turns on if transistor 502 provides a current to the gate of transistor 506.

Method 600 continues at 640, where responsive to turning on the second transistor (transistor 506), the reverse polarity turn-on circuit 122 turns on a third transistor, where the third transistor provides a path for a reverse polarity parasitic current in the third transistor. The third transistor in this example is high-side FET 102. Turning on high-side 102 during reverse polarity prevents the reverse polarity parasitic current from traveling through body diode 104, which can create SCR action in high-side FET 102. Therefore, the reverse polarity turn-on circuit 122 protects high-side FET 102 and other circuit components in driver 101.

In examples herein, a reverse polarity turn-on circuit is coupled to a control terminal of a high-side FET in a driver circuit. During a reverse polarity condition, the reverse polarity turn-on circuit detects the reverse polarity and turns on the high-side FET to provide a channel for current to flow through the high-side FET, rather than flowing through the body diode of the high-side FET. If the current flows the channel of the high-side FET, the parasitic SCR within the high-side FET is not triggered. The circuit is therefore protected from the high current caused by the SCR action. In examples herein, the turn-on circuit acts rapidly to prevent the SCR action. The turn-on circuit does not interfere with the operation of the high-side FET during normal operating conditions. Clamping circuitry in the driver circuit and the switching slew rate of the driver circuit are not affected by the reverse polarity turn-on circuit.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While the use of particular transistors are described herein, other transistors (or equivalent devices) may be used instead with little or no change to the remaining circuitry. For example, a metal-oxide-silicon field-effect transistor (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs). In general, herein, a transistor has a control input/control terminal (e.g., a gate, base) and two additional terminals (e.g., source/drain, collector/emitter).

Uses of the term “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A circuit, comprising:
a first transistor having a control terminal coupled to a voltage terminal, having a first terminal coupled to a ground terminal, and having a second terminal;
a second transistor having a control terminal coupled to the second terminal of the first transistor, having a first terminal coupled to the ground terminal, and having a second terminal;
a diode having a first terminal coupled to the control terminal of the second transistor and having a second terminal coupled to a load terminal; and
a third transistor having a control terminal coupled to the second terminal of the second transistor, a first terminal coupled to the voltage terminal, and a second terminal coupled to the load terminal.

2. The circuit of claim 1, wherein the diode is a first diode, and the circuit further comprises:
a second diode having a first terminal coupled to the control terminal of the first transistor, and having a second terminal coupled to the first terminal of the first transistor.

3. The circuit of claim 1, further comprising:
a resistor coupled between the control terminal of the first transistor and the voltage terminal.

4. The circuit of claim 1, further comprising:
a resistor coupled between the second terminal of the first transistor and the control terminal of the second transistor.

5. The circuit of claim 1, wherein the second transistor is configured in a source follower configuration.

6. The circuit of claim 1, further comprising:
a switch having two terminals, a first terminal coupled to a cathode of the diode and a second terminal coupled to an anode of the diode.

7. The circuit of claim 1, wherein the third transistor is a high-side driver transistor.

8. The circuit of claim 1, wherein the first transistor is a P-type field effect transistor, and the second transistor and the third transistor are N-type field effect transistors.

9. The circuit of claim 1, wherein the diode is a first diode, and the circuit further comprises:
a second diode having two terminals, a first terminal coupled to the first terminal of the first transistor, and a second terminal coupled to the ground terminal; and
a third diode having two terminals, a first terminal coupled to the first terminal of the second transistor, and a second terminal coupled to the ground terminal.

10. A circuit, comprising:
a first transistor having a control terminal coupled to a voltage terminal, having a first terminal coupled to a ground terminal, and having a second terminal, the first transistor configured to turn on responsive to a voltage source being in a reverse polarity;
a second transistor having a control terminal coupled to the second terminal of the first transistor, having a first terminal coupled to the ground terminal, and having a second terminal, the second transistor configured to turn on responsive to the first transistor turning on;
a diode having a first terminal coupled to the control terminal of the second transistor and having a second terminal coupled to a load terminal; and
a third transistor having a control terminal coupled to the second terminal of the second transistor, a first terminal coupled to the voltage terminal, and a second terminal coupled to the load terminal, the third transistor configured to turn on responsive to the second transistor turning on.

11. The circuit of claim 10, wherein the third transistor is configured to provide a path for current through the third transistor responsive to the reverse polarity of the voltage source.

12. The circuit of claim 10, wherein the first transistor is configured to turn on responsive to receiving a first voltage at the first terminal of the first transistor and a second voltage at the control terminal of the first transistor, wherein the first voltage is higher than the second voltage.

13. The circuit of claim 10, wherein the diode is configured to limit a voltage at the control terminal of the second transistor.

14. The circuit of claim 10, wherein the diode is a first diode, and the circuit further comprises:
a second diode coupled between the control terminal and the first terminal of the first transistor, wherein the second diode is configured to limit a voltage between the control terminal and the first terminal of the first transistor.

15. The circuit of claim 10, wherein the third transistor is configured to provide a current to the load terminal.

16. A method, comprising:
detecting a reverse polarity of a voltage source, wherein the voltage source is configured to provide a voltage to a driver circuit;
responsive to detecting the reverse polarity of the voltage source, turning on a first transistor;
responsive to turning on the first transistor, turning on a second transistor; and
responsive to turning on the second transistor, turning on a third transistor, wherein the third transistor provides a path for a reverse polarity parasitic current in the third transistor.

17. The method of claim 16, further comprising:
providing the path for the reverse polarity parasitic current through the third transistor responsive to the reverse polarity of the voltage source.

18. The method of claim 16, wherein the first transistor is a P-type field effect transistor, and the second transistor and the third transistor are N-type field effect transistors.

19. The method of claim 16, wherein turning on the first transistor includes providing a first voltage at a first terminal of the first transistor and providing a second voltage at a control terminal of the first transistor, wherein the first voltage is higher than the second voltage responsive to the voltage source being in reverse polarity.

20. The method of claim 16, wherein a diode is coupled between a control terminal of the second transistor and a load terminal, the load terminal coupled to the third transistor.
